(19) United States
(12) Patent Application Publication
(10) Pub. No.: US 2021/0248636 A1
(43) Pub. Date: Aug. 12, 2021

(54) DISTRIBUTED NETWORK SYSTEM FOR OPERATING GROUP FOR NODES INCLUDED IN SYSTEM

(71) Applicant: Ki Eob PARK, Gyeonggi-do (KR)

(72) Inventors: Ki Eob PARK, Gyeonggi-do (KR); Young Uk SON, Gyeonggi-do (KR); Hyun Chel DO, Gyeonggi-do (KR); Joon Woo KIM, Gyeonggi-do (KR); Keon Ryong MOON, Gyeonggi-do (KR); Sung Hyun YOU, Gyeonggi-do (KR); Seok Hee JANG, Gyeonggi-do (KR)

(73) Assignee: Ki Eob PARK, Gyeonggi-do (KR)

(21) Appl. No.: 17/159,022

(22) Filed: Jan. 26, 2021

Related U.S. Application Data
(63) Continuation of application No. PCT/KR2019/009126, filed on Jul. 24, 2019.
(60) Provisional application No. 62/703,896, filed on Jul. 27, 2018.

(30) Foreign Application Priority Data
Sep. 7, 2018 (KR) 10-2018-0107351

(51) Int. Cl. G06Q 30/02; H04L 29/08; H04L 12/66; G06Q 20/36; G06Q 20/38

(52) U.S. Cl. CPC G06Q 30/0215; H04L 67/1044; G06Q 20/389; G06Q 20/3678; H04L 12/66

(57) ABSTRACT

A distributed network includes a plurality of computing devices operably connected to each other over a network and a server. The plurality of computing devices include a first gateway, a distributed database implemented with at least some of the plurality of computing devices over a network, a first memory including a group device list that stores information associated with computing devices included in a first group managed by the first gateway, and a first processor operably connected to the distributed database and the first memory, and a network interface configured to communicate with the distributed network. The server includes a second memory configured to store a gateway list including information associated with a plurality of gateways including the first gateway and a second processor.

### CROSS-REFERENCE TO RELATED APPLICATIONS AND PRIORITY

This application is a continuation of PCT/KR2019/009126, filed Jul. 24, 2019, which claims priority to and the benefit of Korean Patent Application No. 10-2018-0107351, filed on Sep. 7, 2018, and U.S. Provisional Application No. 62/703,896, filed Jul. 27, 2018, the disclosures of which are incorporated herein by reference in their entirety.

### FIELD

Embodiments of the present disclosure relate to peer-to-peer distributed network system technology.

### BACKGROUND

In a network system composed of multiple nodes such as a distributed network system, there occurs a difference between information arrival times of the multiple nodes included in the system. A consensus algorithm may be understood as an algorithm for nodes participating in a network to gain consensus on one result.

A blockchain network system is a distributed network (peer-to-peer (P2P) network) system. For the reliability of the blockchain system, a consensus algorithm is required because all nodes included in the network have to determine the same result value. For example, at present, proof-of-work type, proof-of-stake type, and delegated-proof-of-stake type consensus algorithms are used.

A distributed network system may be composed of a large number of nodes that are spread out in arbitrary regions around the world. This may delay the rate of data or messages being propagated between the nodes.

### SUMMARY

In the case of a conventional consensus algorithm, a node that directly generates a block or a node that owns a certain number of cryptocurrencies or more acquires block rewards. Therefore, nodes in a web environment or mobile environment or nodes with less than a certain number of cryptocurrencies cannot receive block rewards. However, these nodes may contribute to the activation of the ecosystem of a distributed network and especially a blockchain network. Therefore, by paying a reward, it is necessary to attract more nodes to participate.

As the number of nodes participating in the distributed network system increases, the data propagation speed becomes slower. It is possible to increase the speed of the distributed network by grouping nodes that are physically close to each other.

According to an embodiment disclosed herein, a system may include a distributed network including a plurality of computing devices, wherein the plurality of computing devices included in the distributed network are operably connected to each other over a network and wherein a first gateway included in the plurality of computing devices includes a distributed database implemented with at least some of the plurality of computing devices over a network, a first memory including a group device list, wherein the group device list is included in the plurality of computing devices and stores information associated with computing devices included in a first group managed by the first gateway, and a first processor operably connected to the distributed database and the first memory, a network interface configured to communicate with the distributed network, and a server including a second memory configured to store a gateway list including information associated with a plurality of gateways including the first gateway and a second processor, wherein the second processor is configured to determine the first gateway from among the plurality of gateways with respect to a second computing device on the basis of first location information of the plurality of gateways included in the gateway list and second location information received from the second computing device among the plurality of computing devices and transmit information associated with the first gateway to the second computing device, and wherein the first processor is configured to store information associated with the second computing device in the group device list.

According to an embodiment disclosed herein, a server device may include a communication interface configured to communicate with a plurality of computing devices included in a distributed network system, a memory configured to store a gateway list of gateways included in the plurality of computing devices, and at least one processor, wherein the at least one processor is configured to determine a first gateway from among the gateways with respect to the first computing device on the basis of location information of a first computing device, which is not the gateway, among the plurality of computing devices and location information of the gateways included in the gateway list and configured to transmit information associated with the first gateway to the first computing device.

According to embodiments disclosed herein, it is possible to efficiently manage nodes based on the location of the distributed network system and improve the speed of the distributed network system.

In addition, it is possible to provide various advantageous effects that are directly or indirectly obtained through this document.

### DRAWINGS

FIG. 1 is a block diagram of a distributed network system according to an embodiment.

FIGS. 2A and 2B show a diagram illustrating a blockchain structure according to an embodiment, wherein FIG. 2A is a diagram illustrating a blockchain structure includes a plurality of blocks that are linearly connected, and FIG. 2B is a diagram of a block.

FIG. 3 is a diagram illustrating the types of nodes included in a distributed network system according to an embodiment.

FIG. 4 is a block diagram showing a full node according to an embodiment.

FIG. 5 is a block diagram showing a light node according to an embodiment.

FIG. 6 is a block diagram showing a server according to an embodiment.

FIG. 7 is a flowchart illustrating a gateway registration process according to an embodiment.

FIG. 8 is a flowchart illustrating a gateway management operation according to an embodiment.

FIGS. 9A, 9B, and 9C are flowcharts illustrating an operation of a node joining a group according to an embodiment, wherein FIG. 9A illustrates a light node communicates with gateways, FIG. 9B illustrates a light node communicates with a server, and FIG. 9C illustrates a light node communicates with a server to provide information on a gateway to be accessed.

FIG. 10 is a flowchart illustrating an operation of synchronizing a gateway list between servers according to an embodiment.

FIG. 11 is a flowchart illustrating an operation of a gateway generating a block and distributing block rewards to nodes of a group according to an embodiment.

FIG. 12 is a flowchart illustrating an operation of a gateway generating a block and distributing a block reward according to a request from a node in a group according to an embodiment.

FIG. 13 is a flowchart of a method of determining a block generation order of gateways according to an embodiment.

FIGS. 14A and 14B show a diagram illustrating a block generation order of gateways according to an embodiment, wherein FIG. 14A is a diagram illustrating blocks are sequentially generated for one cycle, and FIG. 14B is a diagram illustrating generation of a block generation request.

In describing the drawings, the same or similar reference numerals may be used for the same or similar elements.

### DETAILED DESCRIPTION

Hereinafter, various embodiments of the present invention will be described with reference to the accompanying drawings. It should be understood, however, that there is no intent to limit the invention to the particular forms disclosed, but on the contrary, the invention is to cover various modifications, equivalents, and/or alternatives of the embodiments.

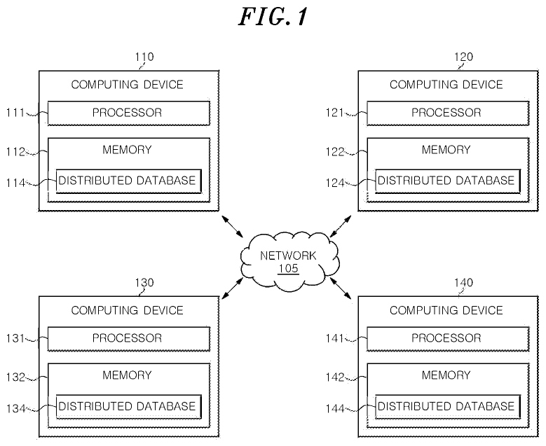

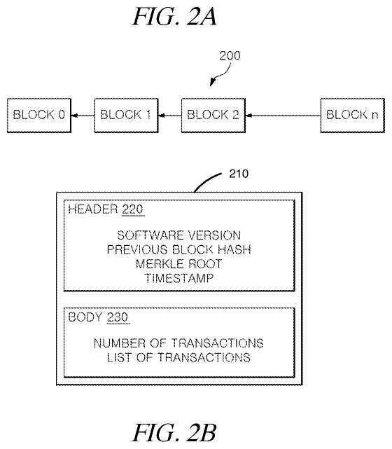

FIG. 1 is a block diagram of a distributed network system 100 according to an embodiment. FIGS. 2A and 2B show a diagram illustrating a blockchain structure according to an embodiment.

The distributed network system 100 may be implemented through a plurality of computing devices 110, 120, 130, and 140. Although four computing devices 110, 120, 130, and 140 are shown in FIG. 1, the distributed network system 100 may further include any number of computing devices not shown.

The network 105 may include a wired network and/or a wireless network. For example, the network 105 may be a local area network (LAN), a wide area network (WAN), a virtual network, or a remote communication network. The computing devices 110, 120, 130, and 140 may be operably connected to each other over a network 105.

The computing devices 110, 120, 130, and 140 may communicate with the network 105 and may transmit and receive data to and from each other over the network 105. Each of the computing devices 110, 120, 130, and 140 may be any type of device configured to transmit data over the network 105 in order to transmit and/or receive data to and from one or more other computing devices. The following description of the computing device 110 may be applied to the other computing devices 120, 130, and 140.

The computing device 110 may include a processor 111 and a memory 112. For example, the memory 112 may include a random access memory (RAM), a memory buffer, a hard drive, a database, an erasable programmable read-only memory (EPROM), an electrically erasable programmable read-only memory (EEPROM), a read-only memory (ROM), and the like.

In some embodiments, the processor 111 may be a general-purpose processor, a field-programmable gate array (FPGA), an application-specific integrated circuit (ASIC), a digital signal processor (DSP), and the like.

In some embodiments, one or more parts of the computing devices 110, 120, 130, and 140 may include a hardware-based module (e.g., a DSP and an FPGA) and/or a software-based module (e.g., a module of computer code stored in a memory and/or executed by a processor). In some embodiments, one or more functions (e.g., functions associated with processors 111, 121, 131, and 141) associated with the computing devices 110, 120, 130, and 140 may be included in one or more modules.

In some embodiments, a memory 112 of the computing device 110 may include a distributed database 114. The computing devices 110, 120, 130, and 140 may implement distributed databases 114, 124, 134, and 144 through a network 105.

The processor 111 may be configured to execute a module, a function, and/or a process to update the distributed database 114 in response to receiving synchronization data or the like associated with a transaction from another processor.

In some embodiments, the distributed database 114 may store transactions generated through the distributed network system 100 and data associated with the transactions in the form of a blockchain structure. Referring to FIGS. 2A and 2B, a blockchain structure 200 is shown as an example. As shown in FIG. 2A, data stored in bock units may be linearly connected to the distributed database 114. Each block may be connected to another by pointing to its preceding block. Referring to FIG. 2B, a block 210 may be composed of a header 220 and a body 230. Data stored in the header 220 will be understood as summary information about the corresponding block 210. A block hash value may be computed based on the data stored in the header 220 of the block 210. A succeeding block can point to a preceding block by storing a hash value of the preceding block. Accordingly, the distributed network system 100 may be referred to as a blockchain network system.

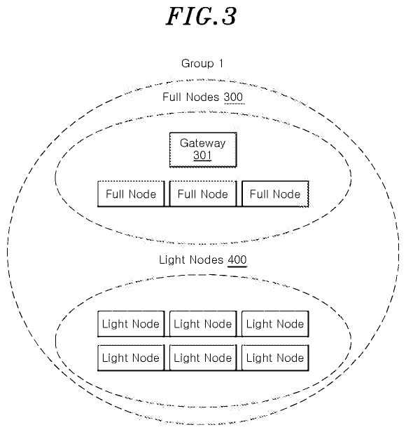

FIG. 3 is a diagram illustrating the types of nodes included in the distributed network system 100 according to an embodiment.

Each computing device (e.g., the computing devices 110, 120, 130, and 140 of FIG. 1) included in the distributed network system 100 may be understood as a node. The nodes included in the distributed network system 100 may be classified into a full node 300 and a light node 400.

The full node 300 is a node that synchronizes and maintains all information (e.g., header 220 information and body 230 information) included in a blockchain 200 in real time. The light node 400 is a node that is capable of performing a transaction function (e.g., a wallet function). The light node 400 may generate a transaction and propagate the generated transaction to neighboring nodes through the network 105. In some embodiments, the light node 400 may verify the generated block with only some information (e.g., header 220 information) included in the blockchain 200.

Hereinafter, the full node 300 and the light node 400 may be collectively referred to as a node included in the distributed network system 100.

The nodes included in the distributed network system 100 may belong to different groups on the basis of location information. Nodes located close to each other may be classified as the same group.

The group may be determined by at least one server 500 communicating with the distributed network system 100. The following description will assume one server 500, but a plurality of servers 500 may perform group classification. The server 500 may classify adjacent nodes as the same group on the basis of location information of the nodes. Accordingly, neighboring nodes that frequently communicate with each other belong to one group, and thus it is possible to increase communication efficiency. The server 500 may be operated by a third party.

At least one of the full nodes 300 may operate as a gateway 301. The gateway 301 may generate a block 210 and manage one group. The gateway 301 may receive a block reward by generating the block 210 and may distribute the received block reward to nodes of a group to which the gateway 301 belongs. Different gateways 301 may manage different groups.

Referring to FIG. 3, group 1 includes four full nodes 300 and six light nodes 400. One of the four full nodes 300 may operate as the gateway 301. The gateway 301 may have information regarding nodes belonging to group 1. When a block reward is received, the gateway 301 may distribute the block reward to the nodes belonging to group 1. The distributed network system 100 may have one or more groups, and each group may have at least one gateway 301.

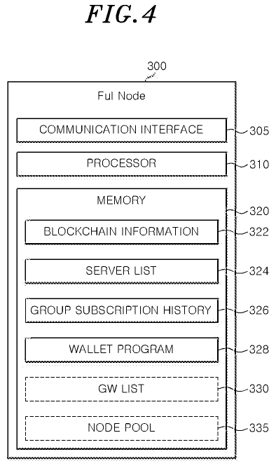

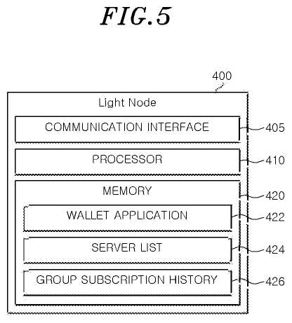

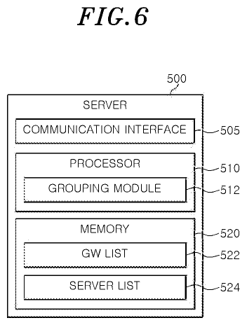

FIG. 4 is a block diagram showing a full node 300 according to an embodiment, and FIG. 5 is a block diagram showing a light node 400 according to an embodiment. FIG. 6 is a block diagram showing a server 500 according to an embodiment.

Referring to FIG. 4, the full node 300 may include a communication interface 305, a processor 310, and a memory 320. The full node 300 may perform communication with the server 500 and nodes included in the distributed network system 100 through the communication interface 305.

For the full node 300, blockchain information 322 (e.g., information associated with the blockchain 200 of FIGS. 2A and 2B), a server list 324, a group subscription history 326, and a wallet program 328 may be stored in the memory 320.

The blockchain information 322 may include all information included in the blockchain 200 of FIGS. 2A and 2B. The full node 300 according to various embodiments disclosed herein may be a personal computer (PC) in a Windows or Linux environment. The full node 300 may have hardware resources capable of storing and synchronizing information related to the blockchain 200 in real time.

The server list 324 may include information associated with servers that perform grouping on the nodes of the distributed network system 100. For example, the server list 324 may include a unique ID of the server 500 and location information (Internet Protocol (IP), latitude, and longitude) of the server 500. The full node 300 may send a request to at least one server 500 included in the server list 324 to join a group or become a gateway 301.

When the full node 300 has previously joined the group, the group subscription history 326 may include information associated with the group. For example, the group subscription history 326 may include account information of the gateway 301 of the group that the full node 300 has joined.

The wallet program 328 may generate transactions such as depositing and transferring of cryptocurrencies in the distributed network system 100. The account of the full node 300 may be a wallet address of the wallet program 328. The wallet program 328 may be a program operating in a Windows or Linux environment.

When the full node 300 operates as the gateway 301, the full node 300 may further include a gateway list 330 and a node pool 335. The gateway list 330 may include information associated with gateways which currently operate as gateways 301 and which operate groups. The gateway list 330 may also be stored in the server 500 and may serve as a backup in an exceptional situation such as an inoperable situation of the server 500.

In various embodiments, one full node 300 may operate as a plurality of gateways. In this case, the plurality of gateways have the same IP and different port numbers.

The node pool 335 may include information associated with nodes (computing devices) belonging to the group operated by the gateway 301. The node pool 335 may include a list of computing devices belonging to the group.

Referring to FIG. 5, the light node 400 may include a communication interface 405, a processor 410, and a memory 420. The light node 400 may perform communication with the server 500 and nodes included in the distributed network system 100 through the communication interface 405.

A wallet application 422, a server list 424, and a group subscription history 426 may be stored in the memory 420 of the light node 400.

The wallet application 422 may generate transactions such as depositing and transferring of cryptocurrencies in the distributed network system 100. The wallet application 422 may be a program operating in a mobile environment such as Android or iOS. The server list 424 and the group subscription history 426 may be the same as the server list 324 and the group subscription history 326 of the full node 300.

Referring to FIG. 6, the server 500 may include a communication interface 505, a processor 510, and a memory 520. The server 500 may perform communication with the nodes (the full node 300 and the light node 400) of the distributed network system 100 through the communication interface 505.

The processor 510 may include a grouping module 512. For example, the processor 510 may execute instructions stored in the memory 520 to drive the grouping module 512. The grouping module 512 may be implemented in hardware or software. An operation performed by the grouping module 512 may be understood as an operation performed by the processor 510. The grouping module 512 may determine groups for nodes on the basis of location information of the nodes.

A gateway list 522 and a server list 524 may be stored in the memory 520. The gateway list 522 may be synchronized with the gateway list 330 stored in the full node 300. The server list 524 may include information on other servers performing the same role as the server 500.

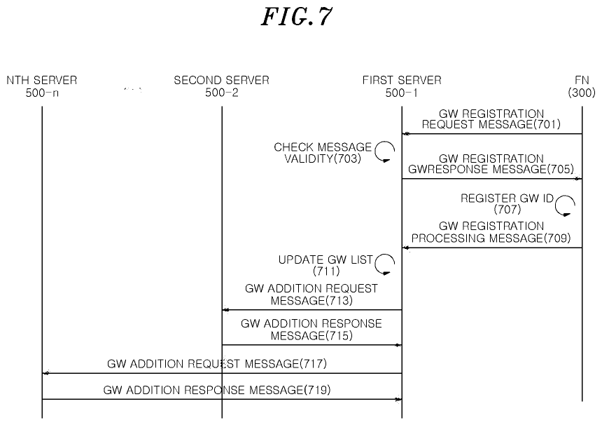

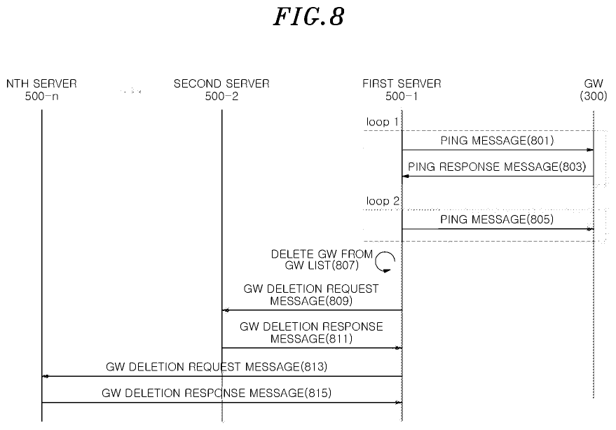

FIG. 7 is a flowchart illustrating a gateway 301 registration process according to an embodiment.

To operate as a gateway 301, a full node 300 may transmit a gateway registration request message to one server (a first server 500-1) (701). The full node 300 may use a server list stored therein to transmit the message to one server included in the server list. For example, an example in which the message is transmitted to the first server 500-1 is shown.

A gateway registration message may include at least one of IP address information of the full node 300, port number information of the full node 300, latitude information of the full node 300, and longitude information of the full node 300. The pieces of information may be understood as information associated with a location of the gateway 301.

The first server 500-1 may check the validity of the received gateway registration message (703) and may transmit a gateway registration response message to the full node 300 (705). The first server 500-1 may compare gateway list information and data included in the gate registration request message. The first server 500-1 may select a gateway 301 adjacent to the full node 300 from the gateway list using information associated with a location of the full node 300.

The gateway registration response message may include a success or failure response (return_val) as the result of processing the gateway registration message and may include a gateway ID to be allocated to the full node 300.

When the processing result included in the gateway registration response message is successful, the full node 300 may register a received gateway ID as its own ID and transmit a gateway registration processing message to the first server 500-1. The gateway registration processing message may include a gateway ID registered by the full node 300. When the processing result included in the gateway registration response message fails, the full node 300 performs operations 701 to 709 for another server included in the server list.

When the gateway registration processing message is received, the first server 500-1 may update the gateway list with the gateway ID included in the gateway registration processing message. The first server 500-1 may propagate the updated gateway list by transmitting a gateway addition request message to other servers. The gateway addition request message may include at least one of the following pieces of information. The gateway addition request message may include a synchronization index (number) of the first server 500-1. The synchronization index may be a number that is updated when the gateway list is updated (i.e., when the gateway is added). For example, the synchronization index may be a number that ranges from 0 to pow(2,32)−1. The gateway addition request message may include the number of gateways registered in the first server 500-1 and the gateway list included in the first server 500-1. The gateway addition request message may include at least one of an IP address, a port number, latitude information, and longitude information of a gateway included in the gateway list.

For example, the gateway addition request message may be transmitted to second to nth servers (500-2 to 500-n) included in the server list stored in the first server 500-1 (713 and 717). Upon receiving the gateway addition request message, the second server 500-2 may identify the first server 500-1 which has transmitted the message. For example, the second server 500-2 may identify the first server 500-1 using an IP of a source from which the message is transmitted. The second server 500-2 may load the gateway list stored in the second server 500-2. In detail, the second server 500-2 may compare a first synchronization index included in the received message and a second synchronization index stored in the second server 500-2. When the first synchronization index is greater than the second synchronization index, the second server 500-2 may update the gateway list stored in the second server 500-2 to the gateway list received through the message and may update its own second synchronization index. When the gateway update process is completed, the second server 500-2 may transmit a gateway addition response message reflecting the processing result to the first server 500-1 (715). Operations 713 and 715 may be performed for the third to nth servers 500-3 to 500-n included in the server list of the first server 500-1 in addition to the second server 500-2.

FIG. 8 is a flowchart illustrating a gateway management operation according to an embodiment.

When the full node 300 is registered as the gateway 301 by the first server 500-1, the first server 500-1 is responsible for the gateway 301. Also, the full node 300 may operate as the gateway 301. The first server 500-1 may periodically check whether a message is reachable to the gateway 301. For example, the first server 500-1 may determine whether the gateway 301 is in operation by transmitting a ping message to the gateway 301 (801) and receiving a response message thereto (803). Operations 801 and 803 may be repeatedly performed every predetermined period (e.g., every two minutes).

For example, a ping message may include any number for identifying the ping message. A ping response message may include any number included in a received ping message. The first server 500-1 may determine that a response to the corresponding ping message is received by comparing the numbers.

When the first server 500-1 repeatedly sends a ping message to the gateway 301 but there is no response, the first server 500-1 may delete the gateway 301 from the gateway list (807). For example, when the first server 500-1 transmits a ping message a predetermined number of times (e.g., three times) but no response is received, the first server 500-1 may determine that an associated program ends in the corresponding gateway 301 or that the network of the gateway 301 is disconnected.

In this case, the first server 500-1 may synchronize the gateway list with those of other servers by transmitting a gateway deletion request message to the other servers (809 and 813). The gateway deletion request message may include a synchronization index (number) of the first server 500-1. The synchronization index may be a number that is updated when the gateway list is updated (i.e., when the gateway is deleted). For example, the synchronization index may be a number that ranges from 0 to pow(2,32)−1. The gateway deletion request message may include the number of gateways registered in the first server 500-1 and the gateway list included in the first server 500-1.

For example, the gateway deletion request message may be transmitted to the second to nth servers 500-2 to 500-n included in the server list stored in the first server 500-1 (809 and 813). Upon receiving the gateway deletion request message, the second server 500-2 may identify the first server 500-1 which has transmitted the message. For example, the second server 500-2 may identify the first server 500-1 using an IP of a source from which the message is transmitted. The second server 500-2 may load the gateway list stored in the second server 500-2. In detail, the second server 500-2 may compare a first synchronization index included in the received message and a second synchronization index stored in the second server 500-2. When the first synchronization index is greater than the second synchronization index, the second server 500-2 may update the gateway list stored in the second server 500-2 to the gateway list received through the message and may update its own second synchronization index. When the gateway update process is completed, the second server 500-2 may transmit a gateway deletion response message reflecting the processing result to the first server 500-1 (811). Operations 809 and 813 may be performed for the third to nth servers 500-3 to 500-n included in the server list of the first server 500-1 in addition to the second server 500-2.

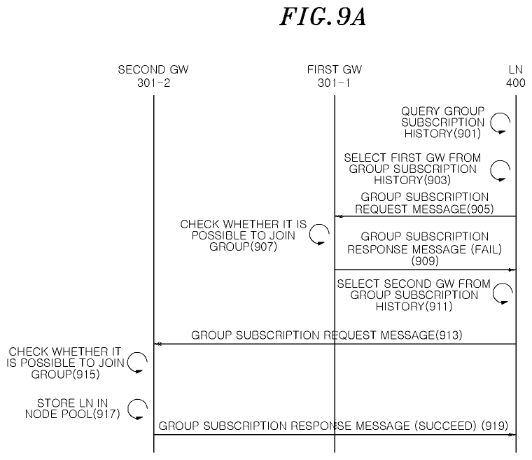

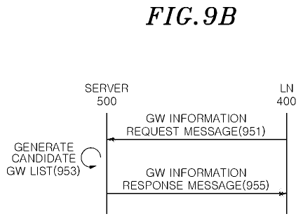

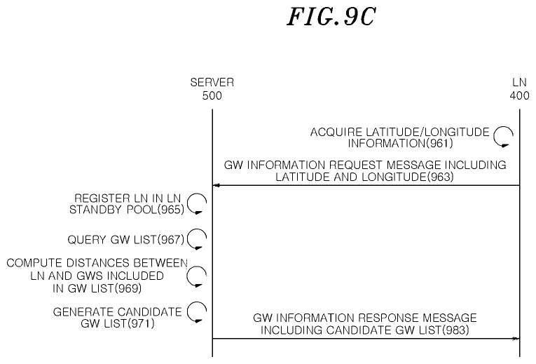

FIGS. 9A, 9B, and 9C are flowcharts illustrating an operation of a node joining a group according to an embodiment.

A full node 300 (a full node not operating as a gateway) and a light node 400 included in a distributed network system 100 may join one group operated by at least one gateway 301. An operation of the light node 400 joining the group will be described below as an example, but the full node 300 may join the group by performing the same operation.

As an example, the light node 400 may include a group subscription history. For example, when the light node 400 has been connected to at least one gateway of the distributed network system 100, the group subscription history may include information associated with the connected gateway.

The light node 400 may query the group subscription history (901). The group subscription history may include an address of the at least one gateway. For example, the address of the gateway may be understood as an address (e.g., a public key and a wallet address) registered on the distributed network system 100. The group subscription history may include, for example, an address of a first gateway 301-1 and an address of a second gateway 301-2. The light node 400 may select the first gateway 301-1 from the group subscription history first (903) and then may transmit a group subscription request message to the first gateway 301-1 (905). The group subscription request message may include an address (e.g., a wallet address) of the light node 400. When the first gateway 301-1 receives the group subscription request message, the first gateway 301-1 may check whether the light node 400 can join the group (907). The first gateway 301-1 may determine the received address of the light node 400 and may determine whether the light node 400 is acceptable. For example, the number of nodes acceptable for each gateway may be limited. The number may be preset according to a software policy and/or a hardware environment of each gateway.

When the light node 400 is acceptable, the first gateway 301-1 may store the address of the light node 400 in a node pool of the first gateway 301-1. The first gateway 301-1 may generate a node ID corresponding to the light node 400 and store the address of the light node 400 and the node ID in the node pool. The address of the light node 400 and the node ID may be mapped and stored.

However, when the first gateway 301-1 cannot accept the light node 400, the light node 400 should send a group subscription request to another node.

The first gateway 301-1 may transmit a group subscription response message to the light node 400 in response to the group subscription request message of the light node 400. The group subscription response message may include a success or failure response to the group subscription request. Also, when the group subscription is successful, a node ID generated for the light node 400 may be included.

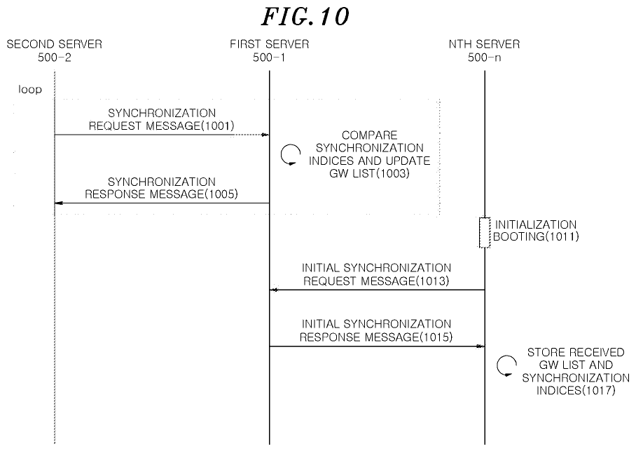

For example, when the light node 400 is not acceptable, the first gateway 301-1 may transmit the group subscription response message including the failure response (e.g., null) to the light node 400 (909). The light node 400 may parse the received group subscription response message, and when a failure is determined, the light node 400 may select a gateway other than the first gateway 301-1 from the group subscription history. When there are no more other gateways in the group subscription history, the light node 400 may perform operations to be described later through FIG. 10.

In FIG. 9A, the light node 400 may select the second gateway 301-2 included in the group subscription history (911). The light node 400 may transmit a group subscription request message to the second gateway 301-2 (913). The second gateway 301-2 may determine the received address of the light node 400 and may determine whether the light node 400 is acceptable (915). When the light node 400 is acceptable, the second gateway 301-2 may store the address of the light node 400 in a node pool of the second gateway 301-2 (917). For example, the second gateway 301-2 may generate a node ID corresponding to the light node 400 and store the address of the light node 400 and the node ID in the node pool. The second gateway 301-2 may transmit a group subscription response message to the light node 400 in response to the group subscription request message of the light node 400 (919). The corresponding group subscription response message may include a success response to a group subscription request and may include a node ID of the light node 400.

Referring to FIG. 9B, when the light node 400 does not include the group subscription history, the light node 400 may transmit a gateway information request message to a server 500 which is one of the servers included in the server list (950). The gateway information request message may include at least one of IP information of the light node 400, port information of the light node 400, latitude information of the light node 400, and longitude information of the light node 400.

The server 500 may generate a candidate gateway list in response to the gateway information request message (953). The server 500 may transmit a gateway information response message (955). The gateway information response message may include the generated candidate gateway list and information on the number of candidate gateways.

The light node 400 may perform the operations 901 to 919 described above with reference to FIG. 9 using the received candidate gateway list. If there is no currently available group, operations 951 to 955 may be repeatedly performed.

Referring to FIG. 9C, as an example, the light node 400 may acquire the latitude information and/or longitude information as location information of the light node 400 (961).

For example, the light node 400 may be a portable device (e.g., a smartphone and a tablet PC). The location of the light node 400 may be changed in real time.

The light node 400 may transmit a gateway information request message including the latitude information and/or longitude information to the server 500 (963). In various embodiments, as the latitude information and/or longitude information of the light node 400 is changed, the light node 400 may request the server 500 to provide information on a gateway to be accessed. Alternatively, the light node 400 may request the server 500 to provide information on a gateway to be accessed on the basis of current location information every predetermined period.

In some embodiments, the gateway information request message may include the number of gateways requested by the light node 400, an IP address of the light node 400, latitude information of the light node 400, and longitude information of the light node 400.

The server 500 may register the light node 400 in a node standby pool (965). When the gateway information request message is transmitted from light nodes, the server 500 may operate the node standby pool in order to sequentially process the requests. The following operations of the server 500 may be performed by the grouping module 512 of the processor 510 of the server 500.

The server 500 may query the gateway list (967) and may compute distances between the light node 400 and the gateways included in the gateway list (969). For example, the server 500 may compute a distance (e.g., a GPS coordinate distance) between the two on the basis of the latitude information and longitude information of the light node 400 and the latitude information and longitude information of the gateways. The server 500 may perform the computation on the gateways included in the gateway list and may determine candidate gateways in ascending order of distance from the light node 400. The server 500 may generate a candidate gateway list including the determined candidate gateways (971). The candidate gateway list may include a number of candidate gateways requested by the light node 400. The server 500 may transmit a gateway information response message including the candidate gateway list to the light node 400 (983).

FIG. 10 is a flowchart illustrating an operation of synchronizing a gateway list between servers according to an embodiment.

The server 500 may share the gateway list included in the server 500 with other servers every predetermined period. Referring to FIG. 10, for example, the synchronization process between the first server 500-1 and the second server 500-2 is illustrated. The second server 500-2 may transmit a synchronization request message for the gateway list to the first server 500-1 (1001). The synchronization request message may include a gateway list and a synchronization index (number) which are stored in the second server 500-2. The synchronization index may be a number that is updated when the gateway list is updated. For example, the synchronization index may be a number that ranges from 0 to pow(2,32)−1.

The first server 500-1 may compare a first synchronization index included in the first server 500-1 and a second synchronization index received from the second server 500-2. When the second synchronization index is greater than the first synchronization index, the first server 500-1 may update the gateway list stored in the first server 500-1 to the gateway list received through the message and may update its own first synchronization index (1003). The first server 500-1 may transmit a synchronization request response message to the second server 500-2. The synchronization request response message may include a processing result (a success or a failure) for a synchronization request. Operations 1001 to 1005 may be performed between different servers included in the distributed network system 100 every predetermined period.

In various embodiments, the nth server 500-n which is newly added may perform initialization booting (1011) and may transmit an initial synchronization request message to the first server 500-1, which is any neighboring server (1013). The first server 500-1 may transmit an initial synchronization response message to the nth server 500-n. The initial synchronization response message may include information regarding the servers included in the distributed network system 100. Information regarding the servers may include the number of servers, a gateway list stored in the servers, the number of gateways, and a synchronization index for the gateway list. When the initial synchronization response message is received, the nth server 500-n may store information included in the message and perform synchronization.

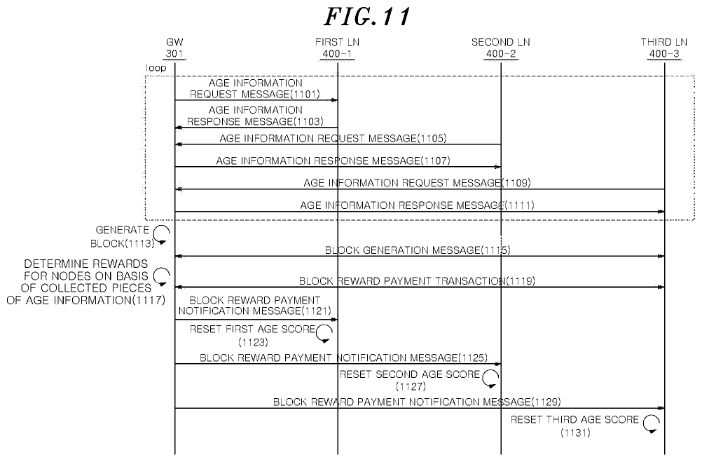

FIG. 11 is a flowchart illustrating an operation of a gateway generating a block and distributing block rewards to nodes of a group according to an embodiment.

For example, the group operated by the gateway 301 may include a first light node 400-1, a second light node 400-2, and a third light node 400-3. The gateway 301 may store, in a node pool, information regarding the nodes included in the group.

The gateway 301 may periodically collect age information from the nodes included in the node pool. The gateway 301 may distribute block rewards to the nodes on the basis of the collected age information. The age information may be proportional to the amount of cryptocurrency owned by the node and may be proportional to the period of possession of the cryptocurrency. Nodes that hold more cryptocurrencies for a longer time will be able to receive more block rewards.

The gateway 301 may periodically transmit an age information request message to the nodes included in the node pool. For example, the gateway 301 may transmit the age information request message to the first light node 400-1, the second light node 400-2, and the third light node 400-3 (1101, 1105, and 1109). The gateway 301 may receive an age response message from the first light node 400-1, the second light node 400-2, and the third light node 400-3 in response to the age information request message. As another example, nodes may periodically transmit age information, and the gateway 301 may collect the age information.

An age information response message may include information on the amounts of cryptocurrency owned by the nodes at a specific time. Alternatively, the age information response message may include a numerical value (score) calculated by each of the nodes. The same algorithm for computing age information may be applied to the nodes included in the distributed network system 100. For example, a first age score for the first light node 400-1, a second age score for the second light node 400-2, and a third age score for the third light node 400-3 may be computed.

The first age score may be mapped to the first light node 400-1 and stored in the node pool.

When its turn comes for block generation, the gateway 301 may generate a block and receive a block reward. For the block reward, the gateway 301 may propagate a block generation message for each block to the distributed network (1115). The gateway 301 may determine rewards to be paid to nodes on the basis of the collected age information (1117).

The block reward may be distributed to the gateway 301 which has generated the block and nodes which are operated by the gateway 301. For example, except for the reward allocated to the gateway 301, the remaining rewards may be distributed to the nodes according to the proportions of the first age score of the first light node 400-1, the second age score of the second light node 400-2, and the third age score of the third light node 400-3. The gateway 301 may pay the determined rewards to accounts (e.g., wallets) of the nodes. For example, the gateway 301 may generate a transaction for paying block rewards to the nodes included in the node pool (1119). After the transaction is generated, the gateway 301 may transmit a notification message for block reward payment to the nodes of the node pool (1121, 1125, and 1131). The first light node 400-1, the second light node 400-2, and the third light node 400-3 may initialize each age score to zero in response to the notification message (1123, 1127, and 1131). Each age score may be recomputed depending on the holding time and amount of cryptocurrency held until the gateway 301 generates the next block.

In various embodiments, the gateway 301 may check whether each node belonging to the group is connected to the corresponding gateway 301 and check the amount of cryptocurrency held by each node every predetermined period (e.g., operations 1101 to 1111). For example, the check operation may be performed every five minutes. The gateway 301 may determine the age score of one node to be proportional to the amount of cryptocurrency held and the number of periods in which it is checked that the node is connected to the gateway 301. The rewards determined in operation 1117 may be equal to the sum of age scores of nodes belonging to the gateway 301 multiplied by the amount of reward paid per age score. Upon receiving the block generation message, full nodes 300 may perform block connection when the sum of the reward for the gateway 301 and the rewards paid to the nodes of the group is equal to the block reward generated for the block generation.

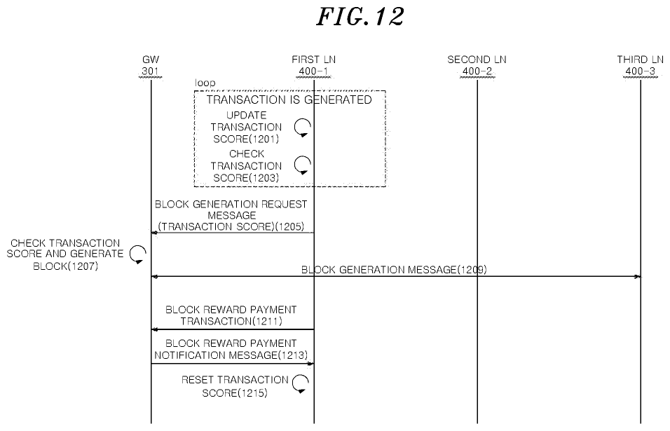

FIG. 12 is a flowchart illustrating an operation of a gateway generating a block and distributing a block reward according to a request from a node in a group according to an embodiment.

Nodes 300 and 400 of the distributed network system 100 may generate various transactions. The generated transactions may be processed by at least one node included in the distributed network system 100 and stored in the blockchain 200.

In some embodiments, a node that generates a large number of transactions may request the gateway of the group to which the node belongs to generate a block. When a node generates a predetermined number of transactions or more, the node can request the gateway 301 to generate a block. The gateway 301 may generate the block and pay a block reward to the node. The corresponding block reward may be an incentive for the nodes included in the distributed network system 100 to generate many transactions.

Each node may generate a transaction and update a transaction score. For example, the first node 400-1 may generate a transaction and update a transaction score (1201). In some embodiments, the transaction score may be determined to be proportional to a fee added to the transaction. For example, the transaction score may be computed as one point per unit fee.

The first node 400-1 may determine whether the updated transaction score is greater than or equal to a predetermined value (1203). Operations 1201 and 1203 may be repeated until the transaction score becomes greater than or equal to the predetermined value. The reference value may be relatively determined depending on the frequency of generation of transactions in the distributed network system 100.

When the transaction score of the first node 400-1 is greater than or equal to the reference value, the first node 400-1 may transmit a block generation request message to the gateway 301, which is an operator of the group to which the first node 400-1 belongs. The bock generation request message may include the transaction score of the first node 400-1 and a list of transactions generated by the first node 400-1. The transactions may be digitally signed by the account of the first node 400-1.

The gateway 301 may verify the transaction list and the transaction score of the first node 400-1 and generate a block (1207). The corresponding block may include an account address of the first node 400-1, which has requested the block generation, and the transaction score received from the first node 400-1.

The gateway 301 may propagate the block generation message over the distributed network (1209). When the gateway 301 receives a block reward, the gateway 301 may distribute the corresponding block reward to the gateway 301 itself and the first light node 400-1. The gateway 301 may generate a transaction for paying the block reward (1211) and transmit a notification message indicating the payment of the block reward to the first light node 400-1 (1213). The first node 400-1 may initialize its transaction score to zero (1215). For example, the first light node 400-1 may confirm a time at which the reward for the corresponding block is paid on the basis of a block issue time stamp associated with the account address of the first light node 400-1.

A policy for determining the transaction score may be applied in common to nodes included in the distributed network system 100. Upon receiving the block generation message, full nodes 300 may verify whether the transaction score for the first light node 400-1 is appropriate and whether the paid reward is appropriate in light of the policy. When the verification is completed, the full nodes 300 may perform block connection.

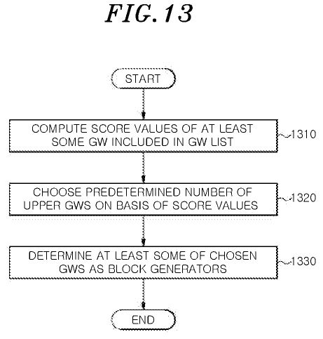

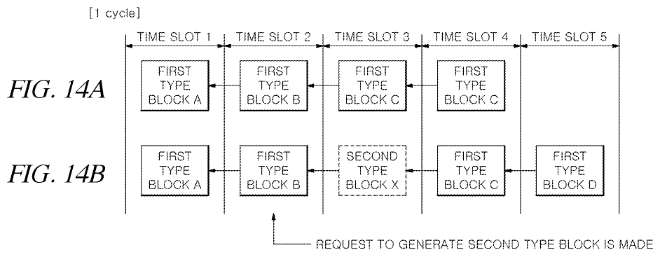

FIG. 13 is a flowchart of a method of determining a block generation order of gateways according to an embodiment. FIGS. 14A and 14B show a diagram illustrating block generation between gateways according to an embodiment.

Among the full nodes 300 included in the distributed network system 100, the gateway 301 may have authority to generate a block. For example, when a certain full node 300 pays a certain deposit (e.g., a certain number of cryptocurrencies) to the distributed network system 100, the full node 300 may operate as the gateway 301. When the gateway 301 returns the gateway authority, the deposit may be returned to the account of the gateway 301.

Each of the gateways 301 may have a list of nodes operating as a gateway (a gateway list) in the distributed network system 100. Whenever the gateway 301 is added or deleted, the gateway lists may be synchronized with each other by the server 500 and/or the gateways 301.

Referring to FIG. 13, a method of determining a block generator according to an embodiment may include operations 1310 to 1330. Operations 1310 to 1330 may be performed by, for example, the full node 300 of FIG. 4. Operations 1310 to 1330 may be implemented using instructions that may be performed by, for example, the processor 310 of the full node 300. The instructions may be stored in, for example, the memory 320 of the full node 300 or a computer recording medium.

In operation 1310, at least one gateway 301 may compute a score value of at least some gateways 301 included in the gateway list.

In some embodiments, a plurality of gateways 301 may be determined to generate a block in descending order of how early the gateways are activated. Also, a gateway that has generated a block and received a reward is pushed down to a lower rank. The gateways 301 may be registered in a block generator pool in the oldest order. For example, the score value may be computed for the top n % of the gateways in the oldest order.

The score value may be set to be computed through a hash function. A hash value of the previous block and an age score value (e.g., the age score value of FIG. 11) may be used as parameters of the hash function. Various known hash functions (e.g., SHA-256) may be used as the hash function. The age score value may be a sum of all age score values of nodes included in a group managed by a specific gateway 301. Information associated with a group managed by a gateway may be used to gain consensus on the authority for block generation. From this point of view, a proof-of-group-stake-type consensus algorithm may be applied to the distributed network system 100.

In operation 1320, at least one gateway 301 may determine a predetermined number (first number) of gateways (a first set) on the basis of the score values. For example, ten gateways may be chosen in descending order of the score value.

In operation 1330, at least some gateways included in the first set may be determined as block generators. In an embodiment, the gateways included in the first set may vote for the block generators. For example, the gateways included in the first set may vote for block generation. Among the gateways included in the first set, gateways that obtain a predetermined number (second number) of votes or more may be determined as the block generators.

Referring to FIG. 14A, the determined block generators sequentially generate blocks for one cycle. For example, gateway A, gateway B, gateway C, and gateway D are determined as the block generators for this cycle. Each of the block generators may generate a block in a time slot in which the corresponding generator is determined to generate the block (fork prevention). Gateway A may be set to generate block A in time slot 1, gateway B may be set to generate block B in time slot 2, node C may be set to generate block C in time slot 3, and gateway D may be set to generate block D in time slot 4. Each of gateways A, B, C, and D may generate a block (a first type of block) through the operations described above with reference to FIG. 11 and may distribute a block reward to nodes of a group to which the corresponding gateway belongs.

In some embodiments, a block generation request may be generated by a node that has satisfied a transaction score within one cycle (e.g., operation 1205 of FIG. 12). Referring to FIG. 14B, a block generation request may be generated from any gateway X in time slot 2. A block generation request may be generated by one node included in a group managed by gateway X. In this case, block X may be generated according to the block generation request in time slot 3, and block generation may be performed by gateways C and D in time slot 4 and time slot 5. Gateway X may generate a block (a second type of block) through the operations described above with reference to FIG. 12 and may distribute a block reward to gateway X and the nodes.

The various embodiments and the terms used herein are not intended to limit the technical features disclosed herein to specific embodiments and should be understood to include various modifications, equivalents, or alternatives of the corresponding embodiments. In describing the drawings, similar reference numerals may be used to designate similar or relevant constituent elements. The singular form of a noun corresponding to an item may include one or more of items, unless the context clearly indicates otherwise. Herein, phrases such as “A or B,” “at least one of A and B,” “at least one of A or B,” “A, B, or C,” “at least one of A, B, and C,” and “at least one of A, B, or C” may include all possible combinations of items listed in the phrases. Terms such as “first” and “second” may simply be used to distinguish corresponding elements from the other elements, and the corresponding elements are not limited in other respects (e.g., importance or order). When a certain (e.g., first) element is referred to as being “coupled” or “connected” to another (e.g., second) element, with or without a term “functionally” or “communicatively,” it means that the certain element can be connected to the other element directly (e.g., by wire), wirelessly, or via a third element.

The term “module” used herein may include a unit implemented in hardware, software, or firmware and may be used interchangeably with, for example, terms such as logic, logic block, component, or circuit. The “module” may be an integrated component, a minimum unit for performing one or more functions, or a part thereof. For example, according to an embodiment, the “module” may be implemented in the form of an application-specific integrated circuit (ASIC).

Various embodiments disclosed herein may be implemented by software (e.g., program #40) including one or more instructions stored in a storage medium (e.g., internal memory #36 or external memory #38) readable by a machine (e.g., electronic device #01). For example, a processor (e.g., processor #20) of the machine (e.g., electronic device #01) may call and execute at least one of the one or more instructions stored in the storage medium. This allows the machine to be operated to perform at least one function in accordance with the at least one called instruction. The one or more instructions may include code generated by a compiler or code executable by an interpreter. The machine-readable storage medium may be provided in the form of a non-transitory storage medium. Here, the term “non-transitory” merely denotes that the storage medium is tangible and does not include a signal (e.g., electromagnetic waves), irrespective of whether data is semi-permanently or temporarily stored in the storage medium.

According to an embodiment, the method according to various embodiments disclosed herein may be included and provided in a computer program product. The computer program product may be traded between a seller and a purchaser as a commodity. The computer program product may be distributed in the form of a machine-readable storage medium (e.g., compact disc read-only memory (CD-ROM)) or may be distributed (e.g., downloaded or uploaded) via an application store (e.g., PlayStore™), directly between two user devices (e.g., smartphones), or online. For online distribution, at least a portion of the computer program product may be at least provisionally generated or temporarily stored in a machine-readable storage medium such as a memory of a manufacturer's server, an application store's server, or a relay server.

According to various embodiments, each of the above-described elements (e.g., modules or programs) may include one or more entities. According to various embodiments, one or more of the above-described elements or operations may be omitted, or one or more other elements or operations may be added. Alternatively or additionally, a plurality of elements (e.g., modules or programs) may be integrated into one element. In such a case, the integrated element may perform one or more functions of each of the plurality of elements in the same or a similar manner as performed by the corresponding one among the plurality of elements prior to the integration. According to various embodiments, operations performed by a module, a program, or other elements may be executed sequentially, in parallel, repeatedly, or heuristically. One or more of the operations may be omitted or executed in different orders. Alternatively, one or more other operations may be added.

1. A system comprising:
a distributed network including a plurality of computing devices, wherein
the plurality of computing devices included in the distributed network are operably connected to each other over a network, and
a first gateway included in the plurality of computing devices comprises:
a distributed database implemented with at least some of the plurality of computing devices over a network;
a first memory including a group device list, wherein the group device list is included in the plurality of computing devices and stores information associated with computing devices included in a first group managed by the first gateway; and
a first processor operably connected to the distributed database and the first memory;
a network interface configured to communicate with the distributed network; and
a server comprising:
a second memory configured to store a gateway list including information associated with a plurality of gateways including the first gateway; and
a second processor,
wherein
the second processor is configured to:
determine the first gateway from among the plurality of gateways with respect to a second computing device on the basis of first location information of the plurality of gateways included in the gateway list and second location information received from the second computing device among the plurality of computing devices; and
transmit information associated with the first gateway to the second computing device, and
the first processor is configured to store information associated with the second computing device in the group device list.

2. The system of claim 1, wherein the second processor is configured to determine a gateway located closest to the second computing device as the first gateway on the basis of the first location information and the second location information.

3. The system of claim 2, wherein
the first location information includes at least one of latitude information and longitude information of the plurality of gateways,
the second location information includes at least one of latitude information and longitude information of the second computing device, and
the second processor is configured to determine the first gateway on the basis of the at least one of the latitude information and longitude information of the second computing device and the at least one of the latitude information and longitude information of the plurality of gateways.

4. The system of claim 1, wherein the first processor is configured to:
acquire a first reward from the distributed network;
determine a second reward for the second computing device from the first reward on the basis of a score of the second computing device; and
pay the determined second reward to an account of the second computing device.

5. The system of claim 4, wherein the first processor is configured to:
transmit a first message to the second computing device every specified period; and
determine a score of the second computing device on the basis of information received in response to the first message.

6. The system of claim 4, wherein the second computing device comprises a memory configured to store a wallet application for accessing the distributed network.

7. The system of claim 5, wherein the information includes the amount of cryptocurrency stored in the account of the second computing device.

8. The system of claim 7, wherein the second reward is determined to be proportional to the amount of cryptocurrency.

9. The system of claim 7, wherein the first processor is configured to initialize the score after paying the second reward to the account of the second computing device.

10. The system of claim 1, wherein the second processor is configured to:
receive a subscription request message for the first group including at least a portion of the information associated with the first gateway; and
store the information associated with the second computing device in the group device list in response to the subscription request message.

11. The system of claim 1, wherein
the distributed database stores data in a blockchain structure, and
the first processor is configured to generate a block and acquire the first reward as a block reward.

12. The system of claim 11, wherein the first processor is configured to:
receive a second message that requests block generation from a third computing device included in the first group;
generate a block and acquire the first reward in response to the second message; and
pay a third reward for the third computing device included in the first reward to an account of the third computing device.

13. The system of claim 12, wherein
the second message includes a transaction score associated with transactions generated by the third computing device, and
the first processor is configured to pay the third reward to the account of the third computing device when the transaction score is greater than or equal to a preset value.

14. A server device comprising:
a communication interface configured to communicate with a plurality of computing devices included in a distributed network system;
a memory configured to store a gateway list of gateways included in the plurality of computing devices; and
at least one processor,
wherein the at least one processor is configured to:
determine a first gateway from among the gateways with respect to the first computing device on the basis of location information of a first computing device, which is not the gateway, among the plurality of computing devices and location information of the gateways included in the gateway list; and
transmit information associated with the first gateway to the first computing device.

15. The server device of claim 14, wherein
a first message including at least one of latitude information and longitude information of the first computing device is received from the first computing device, and
the first gateway is determined based on the at least one of the latitude information and longitude information of the first computing device and the at least one of latitude information and longitude information of the gateways.
